(19) United States
(12) Patent Application Publication
(10) Pub. No.: US 2008/0228980 A1
(43) Pub. Date: Sep. 18, 2008

(54) Microcontroller and Method for the Operation Thereof

(76) Inventor: Riaz Hemmat Esfandabadi, Konigsfeld-Neuhausen (DE)

Correspondence Address: BAKER BOTTS L.L.P.;PATENT DEPARTMENT, 98 SAN JACINTO BLVD., SUITE 1500, AUSTIN, TX, 78701-4039, US

(21) Appl. No.: 12/067,198

(22) PCT Filed: Sep. 18, 2006
(86) PCT No.: PCT/EP06/66448

§ 371 Date: Mar. 18, 2008

(30) Foreign Application Priority Data
Sep. 23, 2005 (DE) 10 2005 045 785.1

(51) Int. Cl. G06F 13/24

(52) U.S. Cl. 710/266

(57) ABSTRACT

A microcontroller (MC) has integrated functional modules (FM) encompassing a first functional module (FM1) which is configured so as to activate or deactivate interrupts (INT). High-frequency triggering events for interrupts are common especially in the preferred field of application of such microcontrollers, i.e. the equipment and operation of digital tachographs, because the signal of a speed sensor has to be recorded also at high speeds. This may affect the process stability when other request sequences are processed. In order to prevent this from happening, the first functional module (FM1) deactivates an interrupt (INT) once requests (IRQ) have been processed and activates said interrupt (INT) again following a delay period (IED) that is associated with the interrupt (INT). The procedure combines the advantages of controlling processes by time intervals and the advantages of an interrupt controller.

### CROSS-REFERENCE TO RELATED APPLICATIONS

This application is a U.S. national stage application of International Application No. PCT/EP2006/066448 filed Sep. 18, 2006, which designates the United States of America, and claims priority to German application number 10 2005 045 785.1 filed Sep. 23, 2005, the contents of which are hereby incorporated by reference in their entirety.

### TECHNICAL FIELD

The invention relates to a microcontroller having integrated functional modules comprising a first functional module, which is in a form such that it activates or deactivates interrupts. In addition, the invention relates to a method for operating a microcontroller, particularly of the aforementioned type.

### BACKGROUND

In a microprocessor or microcontroller, an interrupt (brief interruption in a running program or a command sequence to be executed by a central processing unit), when activated, is triggered immediately or in line with a priority table after a trigger event and the relevant routine associated with the interrupt request is executed. When this routine has been terminated, the central processing unit resumes the work using the interrupted process or the interrupted command sequence. In comparison with task allocation with fixed time intervals, the process management using interrupts has the advantage, in principle, that down times at fixed intervals of time are avoided and also tasks involving different amounts of time can be executed flexibly and without involving additional time. If the trigger events for the interrupts are very frequent or occur at high frequencies, the central processing unit is prevented from performing other tasks and the operation of the appliance to be controlled can be impaired.

Such architecture and associated functionality is based on the microcontroller 80C167 and 80C166 (manufacturer: Infinion), for example.

### SUMMARY

A microcontroller and a method for operating a microcontroller of the respective type cited at the outset can be provided which ensure a stable and economical mode of operation for an appliance equipped accordingly even when there are high-frequency trigger events for interrupts.

According to an embodiment, a microcontroller may comprise integrated functional modules comprising a first functional module, which is it is operable to activate or deactivate interrupts, and activates a deactivated interrupt only after a delay time associated with the interrupt has elapsed, wherein the microcontroller is operable to provide for each interrupt an associated entry or a flag in a register or a main memory which indicates whether there was more than one event triggering an interrupt request during the deactivation of the interrupt.

According to a further embodiment, the first functional module can be an interrupt management unit which is operable to delay the activation of a deactivated interrupt by the period of the delay time associated with the interrupt. According to a further embodiment, the first functional module can be a capture compare unit and the microcontroller is operable to associate the capture compare unit with a particular interrupt. According to a further embodiment, the functional modules may comprise at least one capture compare unit and the microcontroller is operable to associate the capture compare unit with a particular interrupt and the capture compare unit prompts the interrupt management unit to activate the deactivated interrupt. According to a further embodiment, a compare register in the capture compare unit can be used to store a time value, with the period for the time value to match that of a running timer in the capture compare unit corresponding to the delay time. According to a further embodiment, the first functional module, following execution of an interrupt request for the interrupt with which the delay time is associated, may deactivate the interrupt and reactivates it only after the delay time.

According to another embodiment, a method for operating a microcontroller which has at least one interrupt and functional modules comprising a first functional module, may comprise the steps of: in a first step a functional module deactivates a first interrupt, in a second step a future first time value is transferred to a register in the microcontroller, in a third step the first interrupt is activated by the first functional module if the time value in the register matches that of a timer, in a fourth step an interrupt request for the first interrupt is executed, in a fifth step the microcontroller deactivates the first interrupt if the interrupt request for the first interrupt has been executed, and associating each interrupt an entry or a flag, which indicates whether there was more than one event triggering an interrupt request during the deactivation of the interrupt.

According to a further embodiment, the first functional module may be a capture compare unit and the microcontroller is operable to associate the capture compare unit with a particular interrupt for activation or deactivation. According to a further embodiment, the functional modules may comprise at least one capture compare unit and the microcontroller is operable to associate the capture compare unit with a particular interrupt for activation and the capture compare unit prompts the interrupt management unit to activate the deactivated interrupt if there is a match. According to a further embodiment, the compare register in the capture compare unit may be used to store a time value, with the period for the time value to match that of a running timer in the capture compare unit corresponding to the delay time. According to a further embodiment, during the fourth step precisely one interrupt request may be executed and in the fifth step the first functional module may deactivate the first interrupt if an interrupt request for the first interrupt has been executed. According to a further embodiment, in the third step, when the time value stored in the compare register has been reached, the capture compare unit may use a second interrupt to prompt the interrupt management unit to activate the first interrupt. According to a further embodiment, the capture compare unit may be associated with a particular interrupt and in the third step, when the time value in the compare register has been reached, the capture compare unit may prompt the interrupt management unit to activate the first interrupt.

### BRIEF DESCRIPTION OF THE DRAWINGS

The invention is clarified below using an exemplary embodiment with reference to drawings without any restrictive action on the example. In the drawings:

FIG. 1 shows the schematic design of an microcontroller according to an embodiment;

FIG. 2 shows the schematic design of an interrupt management unit according to an embodiment; and

FIG. 3 shows the schematic design of an compare unit according to an embodiment based on another form.

### DETAILED DESCRIPTION

One preferred area of application for a microcontroller according to various embodiments is the equipment and operation of digital tachographs, which need to react to high-frequency signal changes and need to be able to pick up a large number of interrupts to the microcontroller within a very short time, since, particularly at relatively high vehicle speeds, the sensor for the speed signal sends high-frequency signals to the recording unit from the vehicle's transmission. If, particularly in this application, operator control activities by the user additionally arise on the recording unit or if the user attempts to use an integrated thermal printer on the recording unit, for example, to print a report then stability problems arise on the appliance's central processing unit, and ensuring correct operation requires not only particularly powerful hardware but additionally complex control of the processes. These constraints can restrict user-friendliness. The great advantage of the delay time for activation of an interrupt or the extension of the deactivated state according to various embodiments combines the advantages of interrupt control of processes with those of time interval control in a particular way. Only in rare cases is there the need to provide the service linked to the interrupt without delay when the interrupt request is applied. On the other hand, the management of different processes for execution by means of a central processing unit using interrupts is particularly convenient for the aforementioned reasons. The delay time for the activation according to various embodiments allows spasmodically occurring high frequencies for trigger events for interrupts to be moderated in a controlled fashion in the interest of process stability without the need to accept noticeable losses for the process result. In particularly expedient fashion, the function of the first functional module is according to various embodiments already implemented in the hardware of the microcontroller, so that appropriate programming can make use of this function. In addition, there is the advantage that the process of the extended interrupt control according to various embodiments does not require any additional programming complexity or extend the runtime of relevant programs. One particularly advantageous option for using the delay time for the microcontroller's processes according to various embodiments involves the first functional module being an interrupt management unit which has the option of delaying the activation of an interrupt by the period of the delay time associated with the interrupt. Another expedient option involves the first functional module being a capture compare unit which can be at least intermittently associated with a particular interrupt by means of the microcontroller. Combining the two options described above can also provide the advantages according to various embodiments if a capture compare unit in the microcontroller can be associated with a particular interrupt and, after an appropriately associated delay time, prompts the interrupt management unit to activate the deactivated interrupt.

The use of a capture compare unit for directly or indirectly controlling the deactivation of an interrupt is expedient if a compare register in the capture compare unit is used to store a time value, with the period for the time value to match that of a running timer in the capture compare unit corresponding to the delay time. In line with the compare function, the capture compare unit prompts activation of the appropriate interrupt when the time value matches or the delay time elapses. In this context, the hardware of the microcontroller may be in a form such that the capture compare unit either activates the appropriate interrupt directly or prompts the interrupt management unit to do so. To this end, the architecture of the microcontroller can either make a separate provision or provide for an interrupt to be triggered by the capture compare unit, which results in activation of the relevant interrupt by means of the interrupt management unit.

According to an embodiment, the first functional module, following execution of at least one interrupt request for the relevant interrupt with which the delay time is associated, deactivates the interrupt and reactivates it only after the delay time. Instead of at least one interrupt request for the interrupt, provision may also be made for a particular number of the interrupt requests for it or a maximum number to be executed or for all the interrupt requests for the relevant interrupt to be executed. In this regard, provision may be made for a buffer store to temporarily store the application of the interrupt requests. If it is prescribed that only a small number or precisely one interrupt request is to be executed with each delayed activation of the interrupt according to various embodiments then, in particular, high-frequency peak times or heavy utilization levels for the interrupt are increasingly moved to the future. In this context, the particular number of interrupt requests to be executed should be chosen to be sufficiently high for it always to be possible to record execution of all interrupt requests within an acceptable period of time.

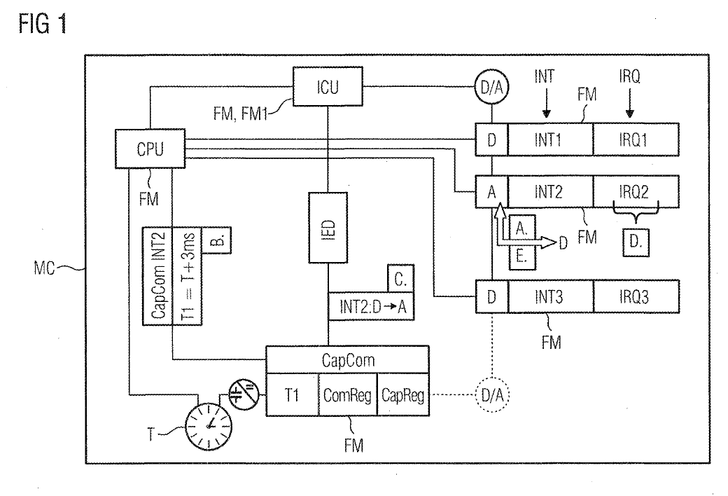

FIG. 1 schematically shows a microcontroller MC according to an embodiment. Method steps are denoted by A. to E. and shown in boxes. Fundamental functional modules FM in the microcontroller MC are a central processing unit CPU, an interrupt management unit ICU, a plurality of interrupts INT and a capture compare unit CapCom, which comprises a timer T. The individual functional modules FM are connected to one another for the purpose of signal transmission. FIG. 1 first of all shows a variant embodiment in which the interrupt management unit ICU corresponds to the first functional module FM1 and accordingly activates and deactivates interrupts INT (indicated as D/A in a circle). In dashes, it shows a second variant, in which the capture compare unit CapCom performs the function of the first functional module FM1 and activates and deactivates the interrupts INT according to an embodiment. The explanations which follow relate to the former variant.

The mode of operation or the mode of the microcontroller MC can be described by way of example according to an embodiment essentially with reference to the 5 steps A. to E. During the first step A., the first functional module FM1 deactivates the interrupt labeled INT2. This circumstance is denoted by an A. In a second step B., the central processing unit CPU sends the capture compare unit CapCom firstly the association with an interrupt (in this case INT2) and secondly the delay time IED in the form of a first time value, T1, which corresponds to a future output (T1=T+3 ms) from the timer. The capture compare unit CapCom transfers the time value T1 to a compare register ComReg and continuously compares it with the value of the timer T. If the time value T1 matches, the first functional module FM1 activates the first interrupt INT2 or INT2 in a third step C. when prompted by the capture compare unit CapCom. Activating (A) the interrupt INT2 results in the interrupt request IRQ2 for this interrupt INT2 being executed during the fourth step D. Following the execution of the interrupt request IRQ2 for the interrupt INT2, the interrupt management unit ICU prompts the deactivation D in the fifth step, labeled E.

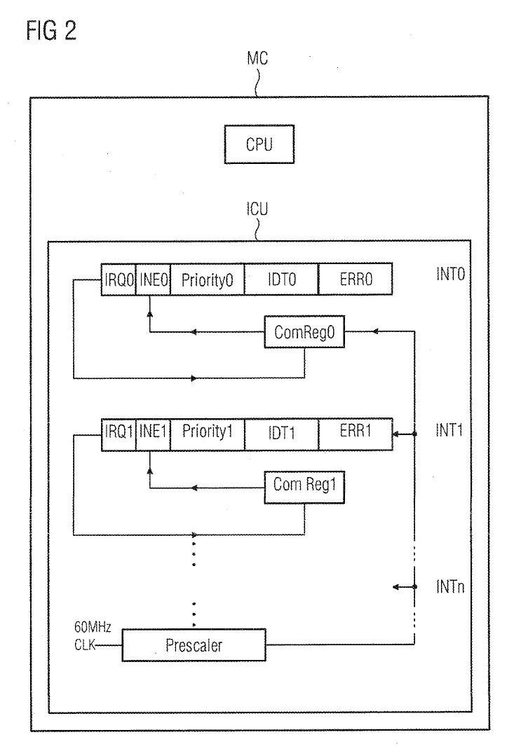

FIG. 2 shows an microcontroller MC according to an embodiment with a central processing unit CPU and an interrupt management unit ICU. The interrupt management unit ICU controls the cycles of the interrupts INT0-INTn. Each interrupt INT0-INTn has the associated entries Interrupt Request IRQ0-IRQn, a binary activation flag IEN0-IENN (also called activation bit), a priority Priority0-PriorityN, a delay time IEDO0-IEDn and an error entry ERR0-ERRn. In addition, each interrupt INT0-INTn has an associated compare register COMREG0-COMREGn, which is continually compared with the value of a system clock CLK. Since the system clock CLK (also called timer) operates at 60 MHz, a scaling unit PRESCALER with a delay 1/10 caters for a lower clock frequency for the comparison value. The scaling unit PRESCALER is expedient for a high system frequency (from the CLK) and divides it into a sensible resolution in line with the requirements from the measurement and registration task. The interrupt management unit ICU activates and deactivates the interrupts INT0-INTn on the basis of the comparison result from the compare register COMREG0-COMREGn with the system clock CLK, so that waiting interrupt requests IRQ can be executed. Between the deactivation of an interrupt INT0-INTn and the subsequent activation, there is the delay time IED0-IEDn. If a plurality of interrupts INT0-INTn have been activated and interrupt requests IRQ to be executed simultaneously are on them, the priority PRIORITY decides which is executed first. If a plurality of interrupt requests IRQ are on the same interrupt INT0-INTn in the phase of deactivation, the error register ERR0-ERRn for the relevant interrupt INT0-INTn is activated to indicate an error.

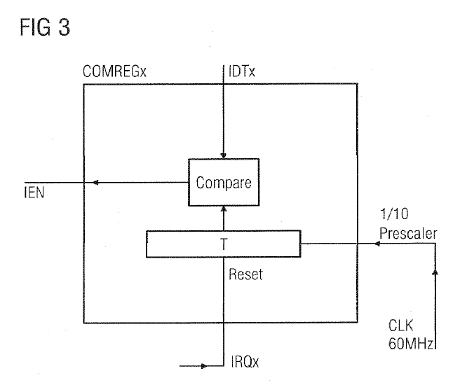

FIG. 3 shows the mode of operation of a compare register COMREG0 according to an embodiment, where the compare register compares a delay time IEDx with the value of a timer T and, if there is a match, activates the appropriately associated interrupt INT0-INTn (IEN). An interrupt request IRQx is used to set the timer in the compare register COMREGx to zero (RESET). The compare unit compares (COMPARE) the value of the timer T with the delay time IEDx.

What is claimed is:

1. A microcontroller comprising integrated functional modules comprising a first functional module, which is it is operable to activate or deactivate interrupts, and activates a deactivated interrupt only after a delay time associated with the interrupt has elapsed, wherein the microcontroller is operable to provide for each interrupt an associated entry or a flag in a register or a main memory which indicates whether there was more than one event triggering an interrupt request during the deactivation of the interrupt.

2. The microcontroller according to claim 1, wherein the first functional module is an interrupt management unit which is operable to delay the activation of a deactivated interrupt by the period of the delay time associated with the interrupt.

3. The microcontroller according to claim 1, wherein the first functional module is a capture compare unit and the microcontroller is operable to associate the capture compare unit with a particular interrupt.

4. The microcontroller according to claim 2, wherein the functional modules comprise at least one capture compare unit and the microcontroller is operable to associate the capture compare unit with a particular interrupt and the capture compare unit prompts the interrupt management unit to activate the deactivated interrupt.

5. The microcontroller according to claim 3, wherein a compare register in the capture compare unit is used to store a time value, with the period for the time value to match that of a running timer in the capture compare unit corresponding to the delay time.

6. The microcontroller according to claim 1, wherein the first functional module, following execution of an interrupt request for the interrupt with which the delay time is associated, deactivates the interrupt and reactivates it only after the delay time.

7. A method for operating a microcontroller which has at least one interrupt and functional modules comprising a first functional module the method comprising the steps of:
in a first step a functional module deactivates a first interrupt,
in a second step a first time value is transferred to a register in the microcontroller,
in a third step the first interrupt is activated by the first functional module if the time value in the register matches that of a timer,
in a fourth step an interrupt request for the first interrupt is executed,
in a fifth step the microcontroller deactivates the first interrupt if the interrupt request for the first interrupt has been executed, and
associating each interrupt an entry or a flag, which indicates whether there was more than one event triggering an interrupt request during the deactivation of the interrupt.

8. The method according to claim 7, wherein the first functional module is a capture compare unit and the microcontroller is operable to associate the capture compare unit with a particular interrupt for activation or deactivation.

9. The method according to claim 7, wherein the functional modules comprise at least one capture compare unit and the microcontroller is operable to associate the capture compare unit with a particular interrupt for activation and the capture compare unit prompts the interrupt management unit to activate the deactivated interrupt if there is a match.

10. The method according to claim 8, wherein the compare register in the capture compare unit is used to store a time value, with the period for the time value to match that of a running timer in the capture compare unit corresponding to the delay time.

11. The method according to claim 8, wherein during the fourth step precisely one interrupt request is executed and in the fifth step the first functional module deactivates the first interrupt if an interrupt request for the first interrupt has been executed.

12. The method according to claim 9, wherein in the third step, when the time value stored in the compare register has been reached, the capture compare unit uses a second interrupt to prompt the interrupt management unit to activate the first interrupt.

13. The method according to claim 9, wherein the capture compare unit is associated with a particular interrupt and in the third step, when the time value in the compare register has been reached, the capture compare unit prompts the interrupt management unit to activate the first interrupt.

14. A microcontroller comprising an interrupt module operable to activate or deactivate interrupts, and to activate a deactivated interrupt only after a delay time associated with the interrupt has elapsed,
means for storing an entry or a flag for each interrupt indicating whether there was more than one event triggering an interrupt request during the deactivation of the interrupt.

15. The microcontroller according to claim 14, wherein the interrupt module is operable to delay the activation of a deactivated interrupt by the period of the delay time associated with the interrupt.

16. The microcontroller according to claim 14, wherein the interrupt module comprises a capture compare unit and the microcontroller is operable to associate the capture compare unit with a particular interrupt.

17. The microcontroller according to claim 15, further comprising functional modules which comprise at least one capture compare unit and the microcontroller is operable to associate the capture compare unit with a particular interrupt and the capture compare unit prompts the interrupt module to activate the deactivated interrupt.

18. The microcontroller according to claim 16, wherein a compare register in the capture compare unit is used to store a time value, with the period for the time value to match that of a running timer in the capture compare unit corresponding to the delay time.

19. The microcontroller according to claim 14, wherein the interrupt module, following execution of an interrupt request for the interrupt with which the delay time is associated, deactivates the interrupt and reactivates it only after the delay time.
